(19) United States
(12) Patent Application Publication
(10) Pub. No.: US 2018/0189374 A1
(43) Pub. Date: Jul. 5, 2018

(54) SYSTEM AND METHOD FOR FAST READING OF SIGNAL DATABASES

(71) Applicant: ARROW DEVICES PRIVATE LIMITED, Bengaluru (IN)

(72) Inventor: ADITYA MITTAL, Bengaluru (IN)

(21) Appl. No.: 15/642,172

(22) Filed: Jul. 5, 2017

(30) Foreign Application Priority Data
Dec. 30, 2016 (IN) 201641045127

(51) Int. Cl. G06F 17/30

(52) U.S. Cl. CPC G06F 17/30598; G06F 17/30002; G06F 17/30477

(57) ABSTRACT

An embodiment herein a method for fast reading of a signal database is provided. The method includes the steps of: (i) obtaining changes in the control signal value corresponds to the one or more signals from the signal database; (ii) grouping each of the one or more signals into the signal group based on the interface that the one or more signals belongs to; (iii) analyzing the control signal value to determine the one or more active cycles and the one or more dead cycles associated with the signal group; (vi) obtaining the one or more clock edge samples from any of (a) the positive edges of the clock signal or (b) the negative edges of the clock signal or (c) both the positive edges and the negative edges of the clock signal; and (v) processing each of the one or more active cycles corresponding to the signal group in parallel to optimize the reading of the signal database.

### CROSS-REFERENCE TO RELATED APPLICATIONS

This application claims priority to Indian patent application no. 201641045127 filed on Dec. 30, 2016, the complete disclosure of which, in its entirely, is herein incorporated by reference.

### BACKGROUND

### Technical Field

The embodiments herein generally relate to analyzing one or more signals whose value changes are recorded in a signal database (e.g. signal databases may be a signal dump file or any other file or a memory based database), and, more particularly to a method for identifying active time regions for each group of signals and extracting one or more signal value changes during the identified active time regions from the signal database and analyzing each of the one or more of signal values corresponding to different signal groups in parallel.

### Description of the Related Art

The value changes in signals of a logic circuit are captured in a signal database (such as a signal dump file or an in-memory database). The signal database may be in various formats such as VCD (Value Change Dump) or FSDB (proprietary). A logic simulation or emulation process may write this signal dump file. The in-memory database may be implemented as a data structure. This data structure may be updated and maintained based on signal values provided by the logic simulation or emulation process through an Application Programming Interface (API) such as PLI (Programming Language Interface) VPI (Verilog Procedural Interface) or DPI (Direct Programming Interface) or other proprietary APIs). For large designs, a signal databases may have 100's of millions or billions of samples for each signal. Processing such large number of signal samples is expensive in terms of processing time and memory usage. Further, the signal samples need to be processed for various purposes such as recognition of higher abstraction level behavior (or extraction of higher abstraction information) by analyzing signal toggles over a time period covered by the signal database. Additionally, some signal groups may be sampled on a positive edge of their associated clock, and other signal groups may be sampled on a negative edge due to artifacts that prevent a correct sampling on the positive edge. Also, some signals may be asynchronous, with no associated sampling clock.

Therefore, there is a need for a method and a system for fast analysis results of signal databases, preferably in minutes and seconds instead of hours of runtime.

### SUMMARY

In one aspect, a method for fast reading of a signal database is disclosed. The method includes the following steps: (a) obtaining changes in control signal value corresponds to one or more signals from the signal database, wherein the one or more signals comprise a control signal and a data signal; (b) grouping each of the one or more signals into a signal group based on an interface that the one or more signals belongs to; (c) determining a clock signal that the one or more signals of the signal group are synchronous with; (d) analyzing the control signal value to determine one or more active cycles and one or more dead cycles associated with the signal group, wherein the analyzing comprises, wherein the analyzing includes the steps of: (A) obtaining a plurality of clock edge samples from any of (i) positive edges of the clock signal or (ii) negative edges of the clock signal or (iii) both the positive edges and the negative edges of the clock signal; (B) determining the plurality of clock edge samples as active cycles when the control signal value is high or asserted; and (C) determining the plurality of clock edge samples as dead cycles when the control signal value is low or de-asserted; and (h) processing each of the one or more active cycles corresponding to the signal group in parallel to optimize the reading of the signal database.

In one embodiment, when the one or more signals are asynchronous signal, the method comprising the step of: (i) determining the one or more active cycles when the control signal value is high or asserted; (ii) determining the one or more dead cycles when the control signal value is low or de-asserted; and (iii) processing the one or more active cycles corresponding to the signal group in parallel to optimize the reading of the signal database.

In another embodiment, when the interface is in an idle state, the plurality of clock edge samples that are obtained during a time are marked as dead cycles, wherein the plurality of clock edge samples is filtered or skipped without affecting an output of decoding of the one or more signals to extract functional transactions on the interface by analyzing signal toggles

In yet another embodiment, when the signal group includes multiple control signals, the multiple control signals are processed using a Boolean function to obtain a single control signal, wherein the Boolean function is determined based on a functionality of a circuit.

In yet another embodiment, the method further includes the step of (a) sampling the data signal using any of (i) the positive edges of the clock signal or (ii) the negative edges of the clock signal or (iii) both the positive edges and the negative edges of the clock signal; and (b) processing each of the one or more active cycles corresponding to different signal groups in parallel to optimize said reading of said signal database.

In one embodiment, the one or more dead cycles includes a window of time that is a subset of a region of the time when the control signal is de-asserted or low.

In another aspect, a system for fast reading of a signal database is provided. The system comprising a memory, and a processor. The memory stores a set of modules and a database. The processor executes the set of modules. The set of modules includes a signal value change obtaining module, a signal grouping module, a clock signal determining module, a signal value analyzing module, and an active cycle processing module.

The signal value change obtaining module obtains changes in control signal value corresponds to one or more signals from the signal database. In one embodiment, the one or more signals include a control signal and a data signal. The signal grouping module groups each of the one or more signals into a signal group based on an interface that the one or more signals belongs to. The clock signal determining module determines a clock signal that the one or more signals of the signal group are synchronous with. The signal value analyzing module analyzes the control signal value to determine one or more active cycles and one or more dead cycles associated with the signal group. The signal value analyzing module includes a clock edge sampling module, an active cycle determination module, and a dead cycle determination module.

The clock edge sampling module obtains a plurality of clock edge samples from any of (i) positive edges of the clock signal or (ii) negative edges of the clock signal or (iii) both the positive edges and the negative edges of the clock signal. The active cycle determination module determines the plurality of clock edge samples as active cycles when the control signal value is high or asserted. The dead cycle determination module determines the plurality of clock edge samples as dead cycles when the control signal value is low or de-asserted. The active cycle processing module processes each of the one or more active cycles corresponding to the signal group in parallel to optimize the reading of the signal database.

In one embodiment, wherein when the one or more signals are asynchronous signal, (i) the active cycle determination module determines the one or more active cycles when the control signal value is high or asserted; (ii) (ii) the dead cycle determination module determines the one or more dead cycles when the control signal value is low or de-asserted; and (iii) the active cycle processing module processes the one or more active cycles corresponding to the signal group in parallel to optimize the reading of the signal database.

In another embodiment, when the interface is in an idle state, the plurality of clock edge samples that are obtained during a time are marked as dead cycles, wherein the plurality of clock edge samples is filtered or skipped without affecting an output of decoding of the one or more signals to extract functional transactions on the interface by analyzing signal toggles.

In yet another embodiment, when the signal group comprises multiple control signals, the multiple control signals are processed using a Boolean function to obtain a single control signal, wherein the Boolean function is determined based on a functionality of a circuit.

In yet another embodiment, the system further includes a data signal sampling module that samples the data signal using any of (i) the positive edges of the clock signal or (ii) the negative edges of the clock signal or (iii) both the positive edges and the negative edges of the clock signal.

In yet another embodiment, the one or more dead cycles includes a window of time that is a subset of a region of time when the control signal is de-asserted or low.

The system processes the one or more signal in the signal database in minutes or seconds instead of hours. The system processes a group of related signals in parallel on an operating system that supports multi-processing.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is an exploded view of a system to analyze one or more of signals in a signal database according to an embodiment herein;

FIGS. 2A-2B are flow diagrams that illustrate a method that (i) optimally reads signal value changes when the one or more of signals of a signal group are synchronous to a clock signal and (ii) skips each of the one or more dead cycles and reads and processes only each of the one or more active cycles from the signal database of FIG. 1 according to an embodiment;

FIG. 3 is a flow diagram that illustrates an optimized method that (i) reads signal value changes when the signals of the signal group are asynchronous and (ii) skips dead cycles and reads and processes only active cycles from the signal database of FIG. 1 according to an embodiment herein;

FIG. 4 illustrates the one or more dead cycles and the one or more active cycles and how each of the one or more dead cycles are skipped for optimizing the reading and processing of signals synchronous to a clock of according to an embodiment herein;

FIG. 5 illustrates the one or more dead cycles and the one or more active cycles and how each of the one or more dead cycles are skipped for optimizing the reading and processing of asynchronous signals according to an embodiment herein;

FIG. 6 illustrates the one or more dead cycles and the one or more active cycles and how each of the one or more dead cycles are skipped for optimizing the reading and processing of multiple control signals synchronous to the clock according to an embodiment herein;

FIG. 7 is a flow diagram that illustrates a method for fast reading of the signal database of FIG. 1 according to an embodiment herein;

FIG. 8 illustrates an exploded view of the system of FIG. 1 according to an embodiment herein; and

FIG. 9 illustrates a schematic diagram of a computer architecture used according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

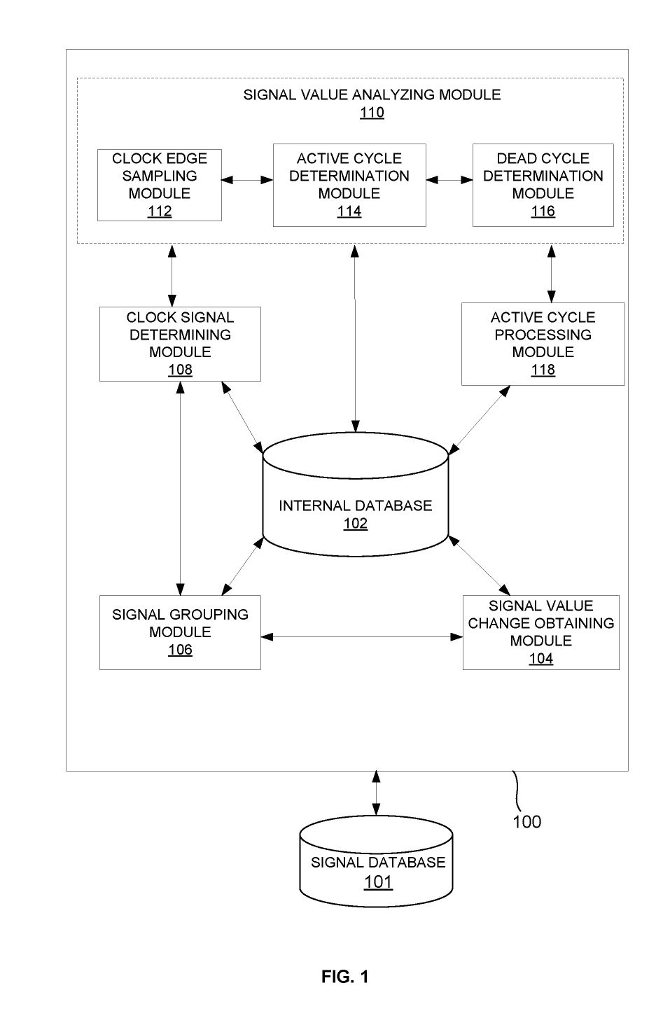

As mentioned, there remains need for a system and a method for identifying one or more of active cycles in a signal database and processing one or more signal value changes of a signal group during the active cycles as multiple parallel processes. Referring now to the drawings, and more particularly to FIGS. 1 through 9, where similar reference characters denote corresponding features consistently throughout the figures are shown preferred embodiments.

FIG. 1 is an exploded view of a system 100 to analyze one or more of signals in a signal database 101 according to an embodiment herein. The system 100 includes a signal database 101, an internal database 102, a signal value change obtaining module 104, a signal grouping module 106, a clock signal determining module 108, a signal value analyzing module 110, a clock edge sampling module 112, an active cycle determination module 114, a dead cycle determination module 116, and an active cycle processing module 118. The signal value change obtaining module 104 obtains changes in control signal value corresponds to one or more signals from the signal database 101. The signal database 101 may be but it is not limited to a value change dump (VCD) file, a FSDB file, or an in memory data structure populated by data extracted from logic simulation and emulation processes through an Application Programming Interface (APIs) such as PLI (Programming Language Interface), DPI (Direct Programming Interface) and the like.

The signal database 101 records signal value changes for the one or more signals from a start time till an end time. The one or more signals comprise a control signal and a data signal. The signal grouping module 106 groups each of the one or more signals into a signal group based on an interface that the one or more signals belongs to. The one or more signals that belong to the signal group will be functionally related to each other. In one embodiment, each of one or more signal groups may correspond to interfaces such as AXI3, PCIE3, USB3 etc. In one embodiment, each signal of the one or more signal groups may be synchronous to the clock signal. The clock signal may be used to record discrete samples of the signal values.

In one embodiment, sampling may be done at a positive edge or a negative edge or both the positive edge and the negative edge of the clock signal associated with the signal group. In another embodiment, in the signal group, one or more clock samples may be discarded without loss of information, according to the functional behavior of the protocol observed by the signal group. For example, in one embodiment, the one or more clock samples that are obtained during the time when the interface is in an idle state is dropped and filtered out by the dead cycle determination module 116 and not passed to the active cycle processing module 118 that decodes functional transactions on the signal interface by analyzing signal toggles, without affecting the output of the process while at the same time reducing the amount of data processed by the process. The clock signal determining module 108 determines the clock signal that the one or more signals of the signal group are synchronous with.

The control signal may be one of the signals of the one or more of signal groups or may be a Boolean function of a subset of signals in the signal group. Each of the one or more dead cycles may be identified based on the control signal. In one embodiment, the one or more clock samples are considered as the one or more dead cycles when the control signal value is computed as 0 (de-asserted). In another embodiment, the one or more clock samples are considered as the one or more active cycles when the control signal value is computed as 1 (asserted). In another embodiment, a window of time that is a subset of the region of time when the control signal is de-asserted may be considered as the one or more dead cycles. The signal value analyzing module 110 includes the clock edge sampling module 112, the active cycle determination module 114, and the dead cycle determination module 116. The signal value analyzing module 110 analyzes the control signal value to determine one or more active cycles and one or more dead cycles associated with the signal group.

The clock edge sampling module 112 obtains one or more clock edge samples from any of (i) positive edges of the clock signal or (ii) negative edges of the clock signal or (iii) both the positive edges and the negative edges of the clock signal. The active cycle determination module 114 determines the one or more clock edge samples as active cycles when the control signal value is high or asserted. The dead cycle determination module 116 determines the one or more clock edge samples as dead cycles when the control signal value is low or de-asserted. The active cycle processing module 118 processes each of the one or more active cycles corresponding to the signal group in parallel to optimize fast reading of the signal database 101.

In one embodiment, when the one or more signals are asynchronous signal, (i) the active cycle determination module 114 determines the one or more active cycles when the control signal value is high or asserted, (ii) the dead cycle determination module 116 determines the one or more dead cycles when the control signal value is low or de-asserted, and (iii) the active cycle processing module 118 processes the one or more active cycles corresponding to the signal group in parallel to optimize the reading of the signal database 101.

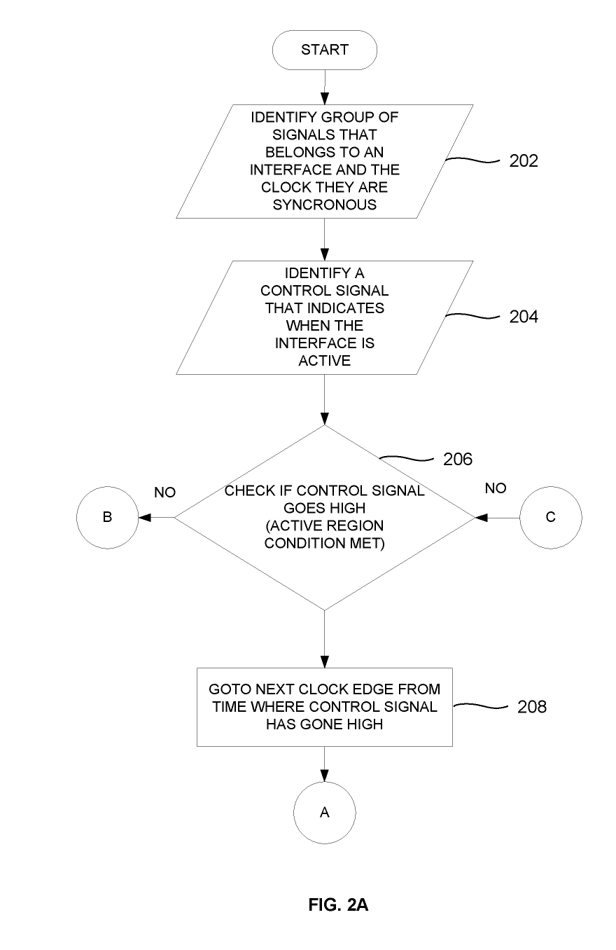

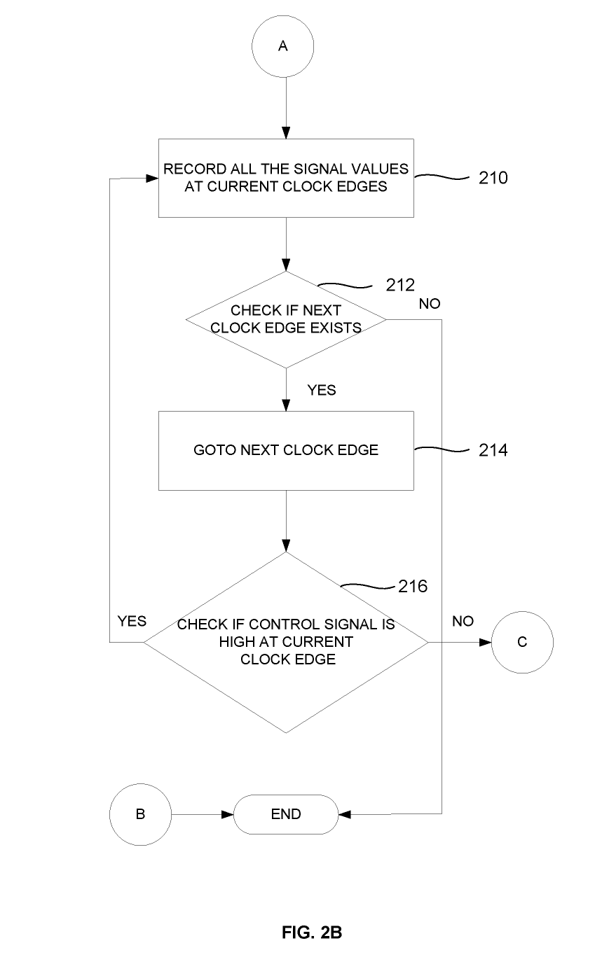

FIGS. 2A-2B are flow diagram that illustrate a method that (i) optimally reads signal value changes when the one or more of signals of a signal group are synchronous to a clock signal and (ii) skips each of the one or more dead cycles and reads and processes only each of the one or more active cycles from the signal database 101 of FIG. 1 according to an embodiment. At step 202, the signals that belong to an interface are grouped together and the clock they are synchronous with is identified. At step 204, a control signal that indicates when the interface is functionally active is identified. At step 206, it checks whether an active region condition is met. If active region condition is met, go to next clock edge at step 208 from the time where the control signal has gone high, else go to END. At step 210, all the signal values at current clock edges are recorded. At step 212, it checks whether a next clock edge exists. If yes, go to the next clock edge at step 214, else go to the END. At step 216, it checks whether the active region condition is met at current clock edge. If yes, go to the step 210 (e.g., record all the signal values at current edges), else go step 206.

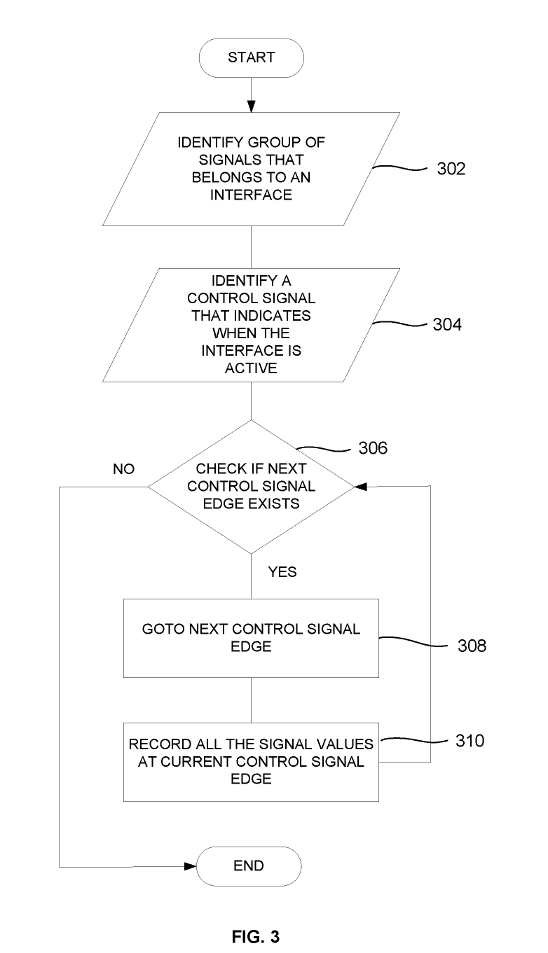

FIG. 3 is a flow diagram that illustrates an optimized method that (i) reads signal value changes when the signals of the signal group are asynchronous and (ii) skips dead cycles and reads and processes only active cycles from the signal database 101 of FIG. 1 according to an embodiment herein. At step 302, the signals that belong to an interface are grouped together. At step 304, the control signal that indicates when the interface is functionally active is identified. Step 306 checks when the control signal transitions from de-asserted to asserted state. In one embodiment, the active region condition stipulates that the control signal is asserted true. Go to timestamp in the signal database 101 where the control signal value changes to true, at step 308. At step 310, the signal values are recorded for the signals of the group. Go to step 306, to determine the next timestamp where signal values need to be recorded. In step 306, if there are no transitions of the control signal from de-asserted to asserted state, then the method ends.

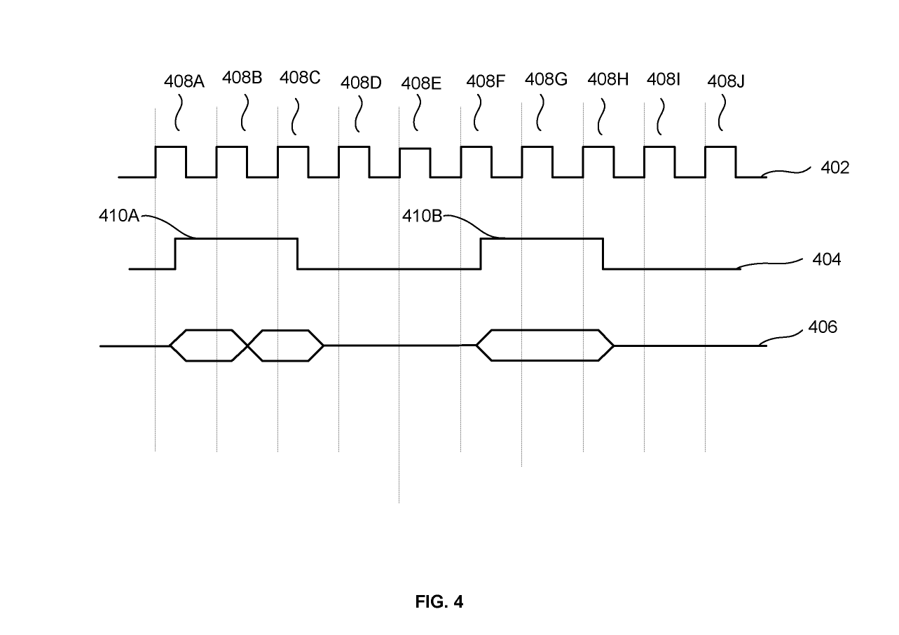

With reference to FIGS. 2A-2B, FIG. 4 illustrates the one or more dead cycles and the one or more active cycles and how each of the one or more dead cycles are skipped for optimizing the reading and processing of signals synchronous to a clock according to an embodiment herein. The figure includes a clock signal 402, the control signal 404, and a data signal 406. In this example, the positive edge of the clock may be used to sample the data signal 406. The clock signal 402 contains one or more of positive clock edges 408A-J. For example, the signal value analyzing module 110 analyzes an activity of each of the one or more of signal values to identify the one or more of active cycles (e.g. 408B, 408C, 408G, 408H) based on the control signal values 410A-B. The remaining cycles (e.g. 408A, 408D, 408E, 408F, 408I, and 408J) may be considered as the one or more of dead cycles which may be skipped.

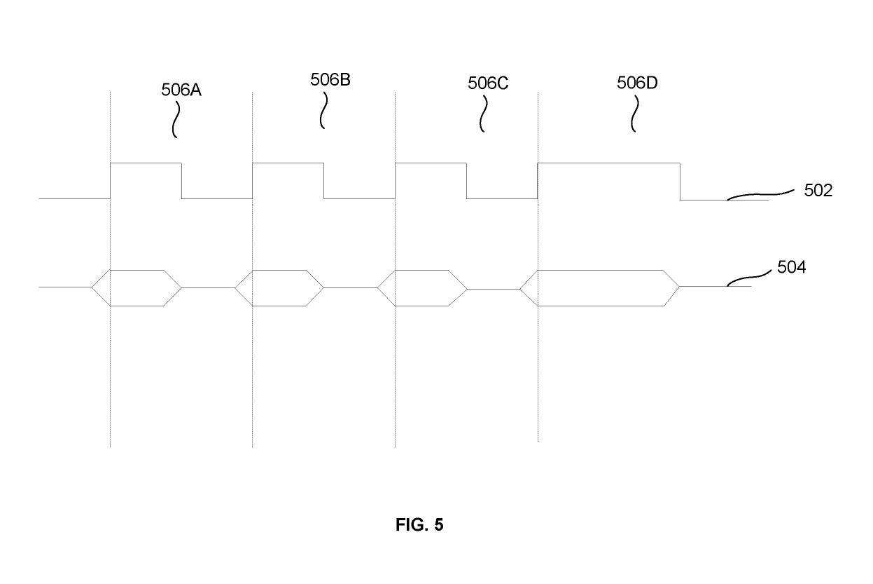

With reference to FIG. 3, FIG. 5 illustrates the one or more of dead cycles and the one or more of active cycles and how each of the one or more of dead cycles can be skipped for optimizing the reading and processing of asynchronous signals according to an embodiment herein. The figure includes a control signal 502 and a data signal 504. For example, the signal analyzing module 110 analyzes activity of each of the one or more of signal values to identify the one or more of active cycles (e.g. 506A, 506B, 506C, 5068D) based on the values of the control signal 502. The remaining signal changes of the data signal 504 may be considered as the one or more of dead cycles. The one or more of dead cycles may be skipped while processing.

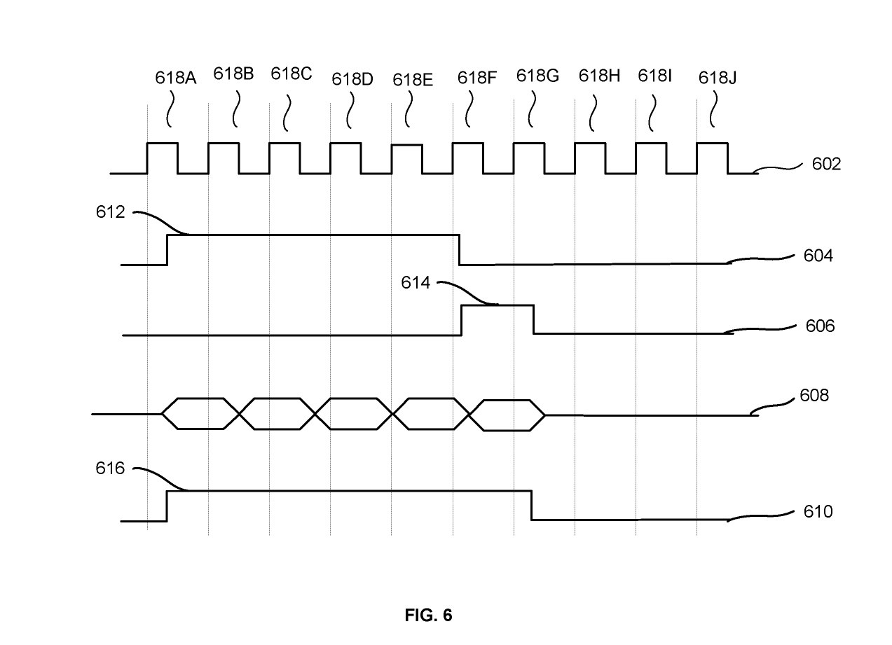

With reference to FIGS. 2A-2B, FIG. 6 illustrates the one or more dead cycles and the one or more active cycles and how each of the one or more dead cycles are skipped for optimizing the reading and processing of multiple control signals synchronous to a clock according to an embodiment herein. FIG. 6 includes a clock signal 602, multiple control signals (e.g. a valid control signal 604 and a last control signal 606), a data signal 608, and a virtual control signal 610. In this example, FIG. 6 depicts a circuit under consideration has two control signals: (i) the valid control signal 604 and (ii) the last control signal 606. The functionality of an interface in the circuit includes starting the active cycles on the assertion (e.g. 612) of the valid control signal 604 and ending after (e.g. 614) the de-assertion of the last control signal 606. For such interface, sampling both the control signals (e.g. the valid control signal 604 and the last control signal 606) and computing a single virtual control signal (e.g. the virtual control signal 610) during the signal dump reading process. In this example, the Boolean expression for calculating the virtual control signal 608 may be as follows.

virtual control signal=valid control signal+last control signal.

For example, the signal value analyzing module 110 analyzes an activity of each of the one or more of signal values to identify the one or more of active cycles (e.g. 618B, 618C, 618D, 618E, and 618F) based on the value (e.g. 616) of the virtual control signal 610. The remaining cycles (e.g. 618A, 618G, 618H, 618I, 618J) may be considered as the one or more of dead cycles which may be skipped. The system 100 processes the virtual control signal 610 as same as the single control signal (e.g. the control signal of FIG. 4).

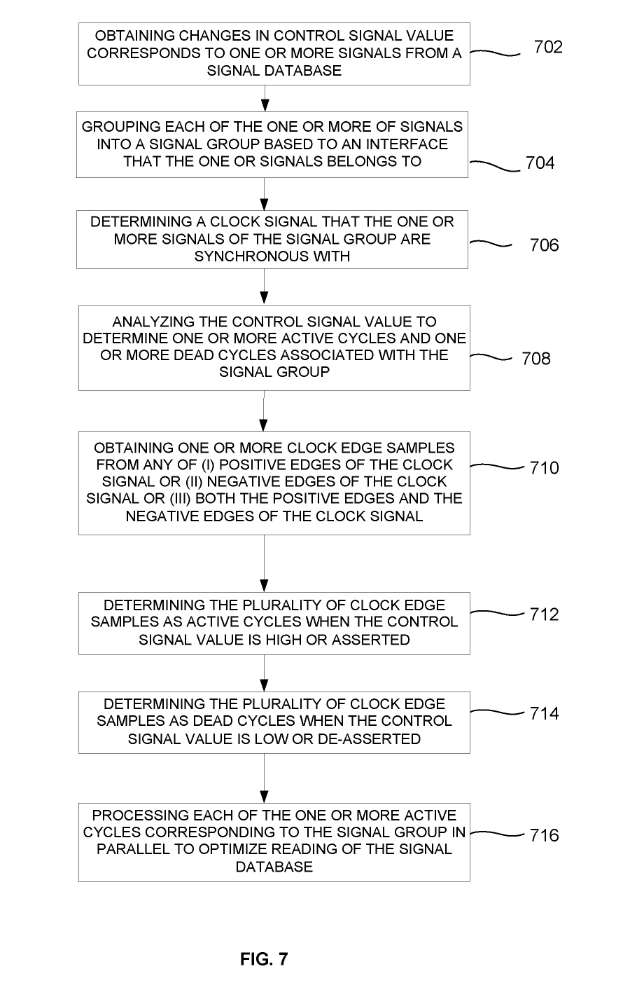

FIG. 7 is a flow diagram that illustrates a method for fast reading of the signal database 101 of FIG. 1 according to an embodiment herein. At step 702, the system 100 obtains changes in the control signal value corresponds to the one or more signals from the signal database 101. At step 704, the system 100 groups each of the one or more signals into the signal group based on the interface that the one or more signals belongs to. At step 706, the system 100 determines the clock signal that the one or more signals of the signal group are synchronous with. At step 708, the system 100 analyzes the control signal value to determine the one or more active cycles and the one or more dead cycles associated with the signal group. At step 710, the system 100 obtains the one or more clock edge samples from any of (i) the positive edges of the clock signal or (ii) the negative edges of the clock signal or (iii) both the positive edges and the negative edges of the clock signal. At step 712, the system 100 determines the one or more clock edge samples as the active cycles when the control signal value is high or asserted. At step 714, the system 100 determines the one or more clock edge samples as the dead cycles when the control signal value is low or de-asserted. At step 716, the system 100 processes each of the one or more active cycles corresponding to the signal group in parallel to optimize the reading of the signal database 101.

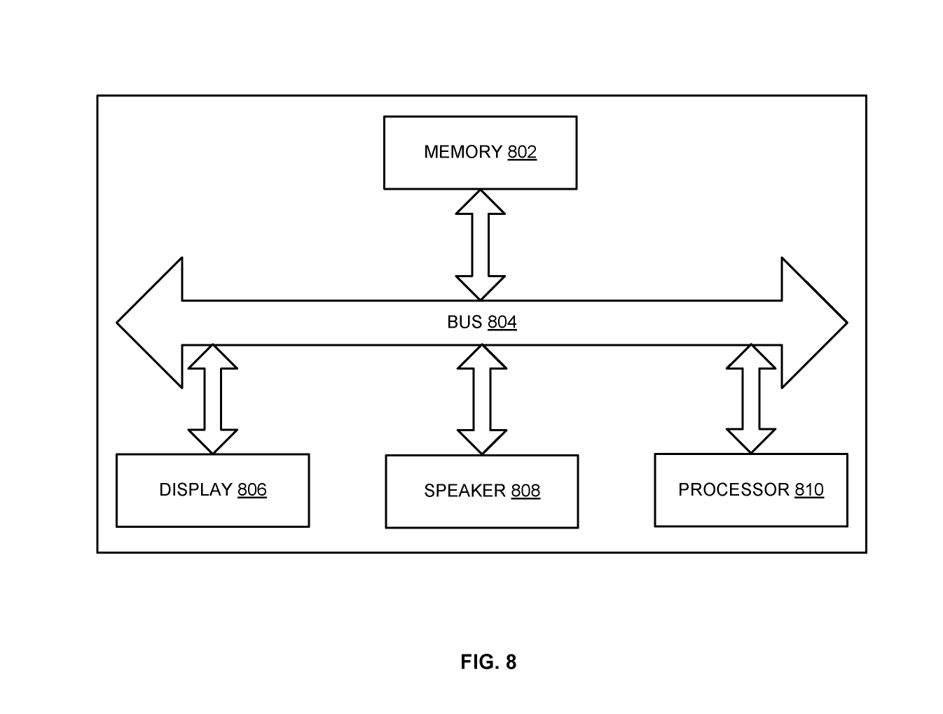

FIG. 8 illustrates an exploded view of the system of FIG. 1 according to the embodiments herein. The system having a memory 802 having a set of computer instructions, a bus 804, a display 806, a speaker 808, and a processor 810 capable of processing a set of instructions to perform any one or more of the methodologies herein, according to an embodiment herein. The processor 810 may also enable digital content to be consumed in the form of video for output via one or more displays 806 or audio for output via speaker and/or earphones 808. The processor 810 may also carry out the methods described herein and in accordance with the embodiments herein. Digital content may also be stored in the memory 702 for future processing or consumption. The memory 802 may also store program specific information and/or service information (PSI/SI), including information about digital content (e.g., the detected information bits) available in the future or stored from the past.

A user of a receiver may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the receiver using the bus 804.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

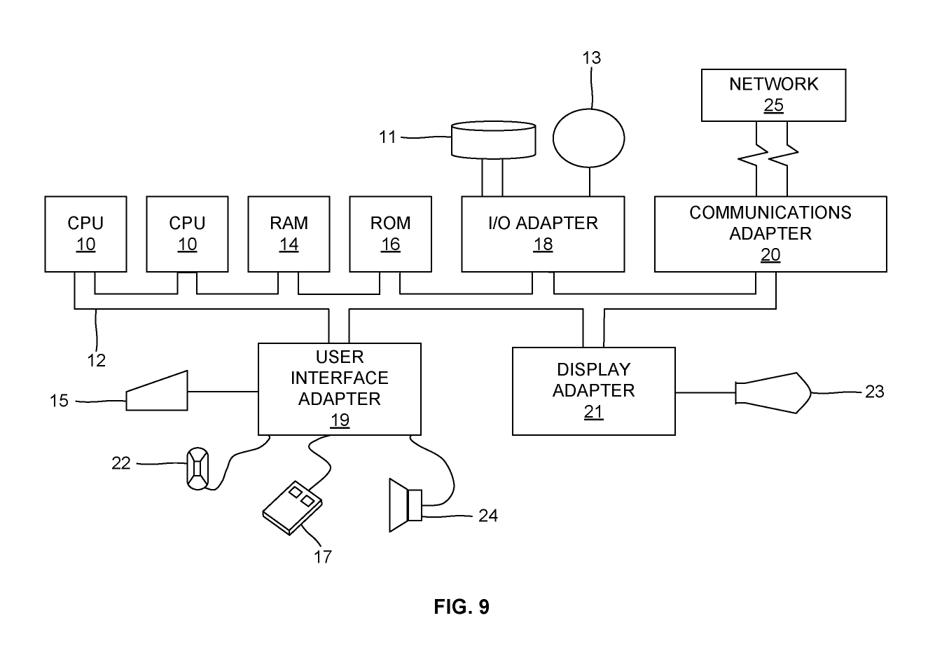

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for fast reading of a signal database, said method comprising:
obtaining changes in control signal value corresponds to one or more signals from said signal database, wherein said one or more signals comprise a control signal and a data signal;
grouping each of said one or more signals into a signal group based on an interface that said one or more signals belongs to;
determining a clock signal that said one or more signals of said signal group are synchronous with;
analyzing said control signal value to determine one or more active cycles and one or more dead cycles associated with said signal group, wherein said analyzing comprises
obtaining a plurality of clock edge samples from any of (i) positive edges of said clock signal or (ii) negative edges of said clock signal or (iii) both said positive edges and said negative edges of said clock signal;
determining said plurality of clock edge samples as active cycles when said control signal value is high or asserted; and
determining said plurality of clock edge samples as dead cycles when said control signal value is low or de-asserted; and
processing each of said one or more active cycles corresponding to said signal group in parallel to optimize said reading of said signal database.

2. The method of claim 1, wherein when said one or more signals are asynchronous signal, said method comprising the step of
determining said one or more active cycles when said control signal value is high or asserted;
determining said one or more dead cycles when said control signal value is low or de-asserted; and
processing said one or more active cycles corresponding to said signal group in parallel to optimize said reading of said signal database.

3. The method of claim 2, wherein when said interface is in an idle state, said plurality of clock edge samples that are obtained during a time are marked as said dead cycles, wherein said plurality of clock edge samples are filtered or skipped without affecting an output of decoding of said one or more signals to extract functional transactions on said interface by analyzing signal toggles.

4. The method of claim 3, wherein when said signal group comprises multiple control signals, said multiple control signals are processed using a Boolean function to obtain a single control signal, wherein said Boolean function is determined based on a functionality of a circuit.

5. The method of claim 4, further comprising
sampling said data signal using any of (i) said positive edges of said clock signal or (ii) said negative edges of said clock signal or (iii) both said positive edges and said negative edges of said clock signal; and
processing each of said one or more active cycles corresponding to different signal groups in parallel to optimize said reading of said signal database.

6. The method of claim 5, wherein said one or more dead cycles comprises a window of time that is a subset of a region of said time when said control signal is de-asserted or low.

7. A system for fast reading of a signal database, said system comprising:
a memory that stores a set of modules and a database; and
a processor that executes said set of modules, wherein said set of modules comprises
a signal value change obtaining module, implemented by said processor, that obtains changes in control signal value corresponds to one or more signals from said signal database, wherein said one or more signals comprise a control signal and a data signal;
a signal grouping module, implemented by said processor, that groups each of said one or more signals into a signal group based on an interface that said one or more signals belongs to;
a clock signal determining module, implemented by said processor, that determines a clock signal that said one or more signals of said signal group are synchronous with;
a signal value analyzing module, implemented by said processor, that analyzes said control signal value to determine one or more active cycles and one or more dead cycles associated with said signal group, wherein said signal value analyzing module comprises
a clock edge sampling module, implemented by said processor, that obtains a plurality of clock edge samples from any of (i) positive edges of said clock signal or (ii) negative edges of said clock signal or (iii) both said positive edges and said negative edges of said clock signal;
an active cycle determination module, implemented by said processor, that determines said plurality of clock edge samples as active cycles when said control signal value is high or asserted; and
a dead cycle determination module, implemented by said processor, that determines said plurality of clock edge samples as dead cycles when said control signal value is low or de-asserted; and
an active cycle processing module, implemented by said processor, that processes each of said one or more active cycles corresponding to said signal group in parallel to optimize said reading of said signal database.

8. The system of claim 7, wherein when said one or more signals are asynchronous signal,
(i) said active cycle determination module determines said one or more active cycles when said control signal value is high or asserted;
(ii) said dead cycle determination module determines said one or more dead cycles when said control signal value is low or de-asserted; and
(iii) said active cycle processing module processes said one or more active cycles corresponding to said signal group in parallel to optimize said reading of said signal database.

9. The system of claim 8, wherein when said interface is in an idle state, said plurality of clock edge samples that are obtained during a time are marked as dead cycles, wherein said plurality of clock edge samples are filtered or skipped without affecting an output of decoding of said one or more signals to extract functional transactions on said interface by analyzing signal toggles.

10. The system of claim 9, wherein when said signal group comprises multiple control signals, said multiple control signals are processed using a Boolean function to obtain a single control signal, wherein said Boolean function is determined based on a functionality of a circuit.

11. The system of claim 10, further comprises
a data signal sampling module, implemented by said processor, that samples said data signal using any of (i) said positive edges of said clock signal or (ii) said negative edges of said clock signal or (iii) both said positive edges and said negative edges of said clock signal.

12. The system of claim 11, wherein said one or more dead cycles comprises a window of time that is a subset of a region of time when said control signal is de-asserted or low.

13. One or more non-transitory computer readable storage mediums storing one or more sequences of instructions, which when executed by one or more processors, by performing the steps of:
obtaining changes in control signal value corresponds to one or more signals from said signal database, wherein said one or more signals comprise a control signal and a data signal;
grouping each of said one or more signals into a signal group based on an interface that said one or more signals belongs to;
determining a clock signal that said one or more signals of said signal group are synchronous with;
analyzing said control signal value to determine one or more active cycles and one or more dead cycles associated with said signal group, wherein said analyzing comprises
obtaining a plurality of clock edge samples from any of (i) positive edges of said clock signal or (ii) negative edges of said clock signal or (iii) both said positive edges and said negative edges of said clock signal;
determining said plurality of clock edge samples as active cycles when said control signal value is high or asserted; and
determining said plurality of clock edge samples as dead cycles when said control signal value is low or de-asserted; and
processing each of said one or more active cycles corresponding to said signal group in parallel to optimize said reading of said signal database.

14. The one or more non-transitory computer readable storage mediums storing one or more sequences of instructions of claim 13, wherein when said one or more signals are asynchronous signal, said method comprising the step of:
determining said one or more active cycles when said control signal value is high or asserted;
determining said one or more dead cycles when said control signal value is low or de-asserted;
processing said one or more active cycles corresponding to said signal group in parallel to optimize said reading of said signal database.

15. The one or more non-transitory computer readable storage mediums storing one or more sequences of instructions of claim 14, wherein when said interface is in an idle state, said plurality of clock edge samples that are obtained during a time are marked as dead cycles, wherein said plurality of clock edge samples are filtered or skipped without affecting an output of decoding of said one or more signals to extract functional transactions on said interface by analyzing signal toggles.

16. The one or more non-transitory computer readable storage mediums storing one or more sequences of instructions of claim 15, wherein when said signal group comprises multiple control signals, said multiple control signals are processed using a Boolean function to obtain a single control signal, wherein said Boolean function is determined based on a functionality of a circuit.

17. The one or more non-transitory computer readable storage mediums storing one or more sequences of instructions of claim 16, further causes
sampling said data signal using any of (i) said positive edges of said clock signal or (ii) said negative edges of said clock signal or (iii) both said positive edges and said negative edges of said clock signal; and
processing each of said one or more active cycles corresponding to different signal groups in parallel to optimize said reading of said signal database.

18. The one or more non-transitory computer readable storage mediums storing one or more sequences of instructions of claim 17, wherein said one or more dead cycles comprises a window of time that is a subset of a region of said time when said control signal is de-asserted or low.
